(19) United States
(12) Patent Application Publication
(10) Pub. No.: US 2007/0045755 A1
(43) Pub. Date: Mar. 1, 2007

(54) Gyro device implemented by back-end semiconductor manufacturing process

(75) Inventors: Jung-Hung Wen, Jhubei City (TW); Weileun Fang, Hsinchu City (TW)

Correspondence Address: MICHAEL W. TAYLOR, P.O. BOX 3791, ORLANDO, FL, 32802-3791, US

(73) Assignee: Analog Integrations Corporation, Hsinchu (TW)

(21) Appl. No.: 11/289,905

(22) Filed: Nov. 30, 2005

(30) Foreign Application Priority Data
Aug. 25, 2005 (TW) 094129152

(51) Int. Cl. G01C 19/38

(52) U.S. Cl. 257/414; 74/5 R

(57) ABSTRACT

The invention relates to a single-chip gyro device, which includes a substrate, a plurality of metal layers and a plurality of dielectric layers, and a plurality of metal side walls. Each of the dielectric layers is located between two adjacent layers selected from a layer group consisting of the metal layers and the substrate. The metal side walls are located on edges of the plurality of dielectric layers so as to prevent the dielectric layers from being undercut and form a mechanical structure together with the metal layers and the dielectric layers to connect the circuit formed on the substrate.

### FIELD OF THE INVENTION

The invention relates to a gyro device, and more particularly to a gyro device implemented by the back-end semiconductor manufacturing process.

### BACKGROUND OF THE INVENTION

The conventional gyro device is operated in a way constantly pointing to a fixed direction by virtue of the concept of conservation of angular momentum. Usually, the gyro device is primarily designed to measure the Coriolis force and is applied to airplanes, airships, satellites, submarines, ships, missiles and so forth. Currently, most of the gyro devices are manufactured in a traditional mechanical means, and hence it is relatively bulky in terms of size and weight. Whereas, if the gyro device is manufactured in a semiconductor means, the mechanical structure and the circuits thereof are first fabricated separately and then connected with wires for the sake of maintaining the sensitivity. This would result in higher noise. For example, please refer to FIG. 1, which shows the schematic diagram of a conventional mechanical gyro device. The conventional mechanical gyro device includes a mechanical structure chip 1 and a circuit chip 2 connected with each other by means of wires 3. This method results in larger parasite effect, bulky components and a higher cost.

Please refer to FIG. 2, which shows a schematic diagram of a single-chip gyro device using the single-chip method to form a BiCMOS circuit 4 and a thick polycrystal layer 5. The drawback of the prior art arises from a rectangular structure, the readout of the sensing signal being prone to be non-linear, the temperature drift and the impact on the stability of the manufacturing process.

As far as the sensing theory of the gyro device is concerned, the formation of a symmetrically angular mechanical structure is the optimal design. However, a single chip integrating the mechanical structure and the circuit has its bottleneck to break through with the current technology. As a result, complicated circuit design is brought into play to overcome the nonlinear variation of the sensing signal, and the asymmetrical signal shift and the mismatching manufacturing process caused by temperature. Meanwhile, the conventional method roughly carries out the layout design without further making the most of the mature standard semiconductor manufacturing process.

For overcoming the drawbacks of the prior art, the present invention provides a novel single-chip gyro device implemented by the back-end manufacturing process, which brings about an improved design of the gyro device.

### SUMMARY OF THE INVENTION

In accordance with a first aspect of the present invention, a gyro device is provided. The provided gyro device contains a substrate, a plurality of metal layers and a plurality of dielectric layers, wherein each of the plurality of dielectric layers is located between two adjacent layers selected from a layer group consisting of the plurality of metal layers and the substrate, and a plurality of metal side walls located on edges of the plurality of dielectric layers.

Preferably, the gyro device is formed on a single chip.

Preferably, the metal layers, the dielectric layers and the metal side walls form a mechanical structure.

Preferably, the mechanical structure is fabricated by a back-end semiconductor manufacturing process.

Preferably, the back-end semiconductor manufacturing process includes an etching process, a chemical vapor deposition process and a planarization process.

Preferably, the gyro device further includes a circuit layer formed on the substrate.

Preferably, the metal side walls and the metal layers provide an electrical connection between the circuit layer and the mechanical structure.

Preferably, the mechanical structure is annular.

Preferably, the mechanical structure is circular.

Preferably, a lowest one of the dielectric layers is removed by an etching process based on a circuit layout design so as to make the mechanical structure movable.

Preferably, the substrate is removed by an etching process based on a circuit layout design so as to make the mechanical structure movable.

In accordance with a second aspect of the present invention, a mechanical structure for a gyro device is provided. The provided mechanical structure contains a plurality of metal layers, a plurality of dielectric layers respectively staggered between two of the metal layers, and a plurality of metal side walls respectively located on edges of the dielectric layers.

Preferably, the mechanical structure is formed on a single-chip gyro device.

Preferably, the mechanical structure is fabricated by a back-end semiconductor manufacturing process.

Preferably, the back-end semiconductor manufacturing process includes an etching process, a chemical vapor deposition process and a planarization process.

Preferably, the single-chip gyro device further includes a substrate and a circuit layer formed on the substrate.

Preferably, the metal side walls and the metal layers provide an electrical connection between the circuit layer and the mechanical structure.

Preferably, the mechanical structure is annular.

Preferably, the mechanical structure is circular.

Preferably, one of the dielectric layers is removed by an etching process based on a circuit layout design so as to make the mechanical structure movable.

The foregoing and other features and advantages of the present invention will be more clearly understood through the following descriptions with reference to the drawing, wherein:

### F BRIEF DESCRIPTION OF THE DRAWINGS

FIG. 1 is a schematic diagram showing the conventional gyro device;

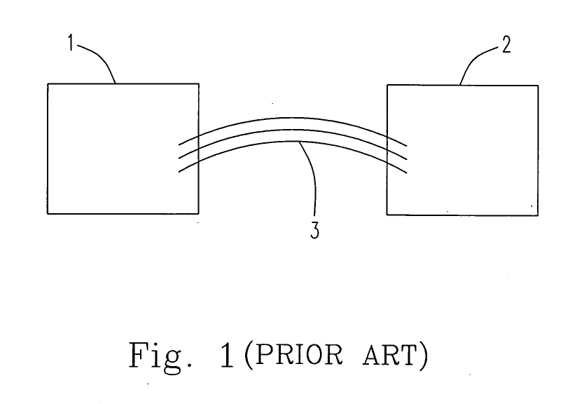

FIG. 2 is a schematic diagram showing the conventional single-chip gyro device;

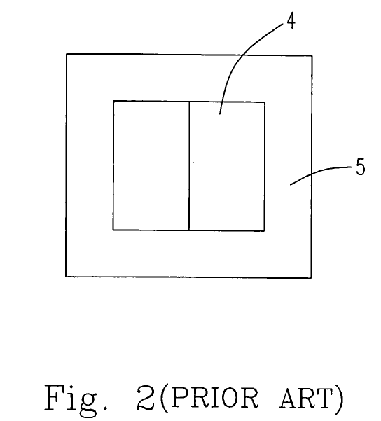

FIG. 3 is a schematic diagram showing the single-chip gyro device prior to etching;

FIG. 4 is a schematic diagram showing the single-chip gyro device after etching;

FIG. 5 is a schematic diagram showing the single-chip gyro device of a preferred embodiment of the present invention prior to etching;

FIG. 6 is a schematic diagram showing the single-chip gyro device of a preferred embodiment of the present invention after etching; and

FIG. 7 is a schematic diagram showing the movable mechanical structure of a preferred embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purposes of illustration and description only; it is not intended to be exhaustive or to be limited to the precise form disclosed.

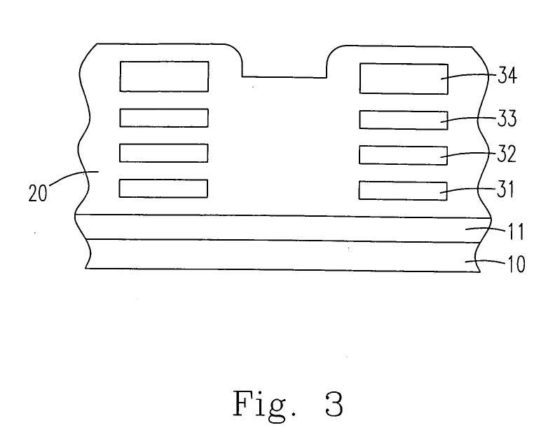

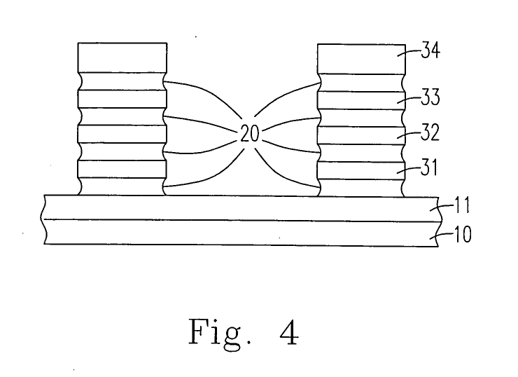

Please refer to FIG. 3, which is a schematic diagram of the conventional single-chip gyro device prior to etching. Prior to etching, the conventional single-chip gyro device contains a substrate 10, a circuit layer 11, a dielectric layer 20, a first metal layer 31, a second metal layer 32, a third metal layer 33 and a fourth metal layer 34. Please refer to FIG. 4, which is a schematic diagram of the conventional single-chip gyro device after etching. After etching, the conventional single-chip gyro device contains the substrate 10, the circuit layer 11, the plurality of dielectric layers 20, the first metal layer 31, the second metal layer 32, the third metal layer 33 and the fourth metal layer 34. It is noted that the mechanical structure is actually cut out by means of an etching process and is composed of all metal layers and dielectric layers. As the wet etching or the dry etching hardly has a perfect selectivity for preparing the etching solution, the dielectric layers are all undercut to form an indentation thereon. Such undercut phenomenon results in the roughness and unevenness of the surface, which deteriorates the external appearance and the quality of the mechanical structure and further adds the difficulty to the designs of the elastic coefficient and the damping of the system. Besides, the existence of the dielectric layers leads to a smaller sensing area of the gyro device, making the sensitivity thereof even worse.

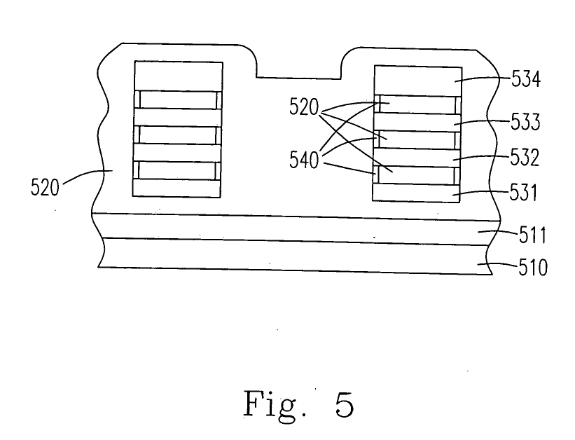

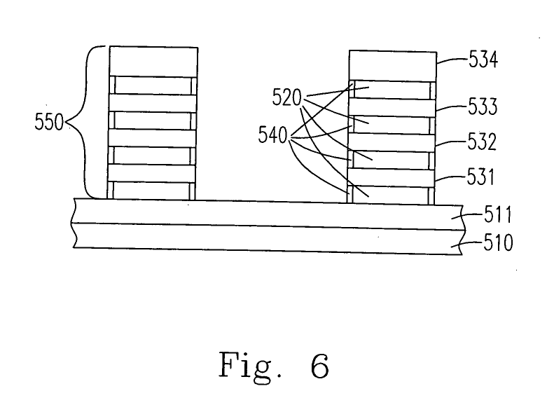

In order to improve the above-mentioned condition and enhance the sensing capability of the gyro device, an improved single-chip gyro device is provided as shown in FIG. 5. Please refer to FIG. 5, which is a schematic diagram of the single-chip gyro device of a preferred embodiment of the present invention prior to etching. The single-chip gyro device contains a substrate 510, a circuit layer 511, a plurality of dielectric layers 520, a first metal layer 531, a second metal layer 532, a third metal layer 533, a fourth metal layer 534 and a plurality of vias 540. Please refer to FIG. 6, which is a schematic diagram of the single-chip gyro device of a preferred embodiment of the present invention after etching. After etching, the single-chip gyro device contains the substrate 510, the circuit layer 511, the plurality of dielectric layers 520, the first metal layer 531, the second metal layer 532, the third metal layer 533, the fourth metal layer 534 and the plurality of vias 540. The metal layers 531, 532, 533 and 534 are formed on the substrate 510, and the lowest one of the dielectric layers 520 is formed between the substrate 510 and the metal layer 531. Either of the dielectric layers 520 is formed between two of the metal layers 531, 532, 533 and 534. The metal layers 531, 532, 533 and 534 and the dielectric layers 520 are formed as a mechanical structure 550. The vias 540 that form a metal side wall connect the metal layers 531, 532, 533 and 534 and are exposed outside the dielectric layers 520 so as to prevent the dielectric layers 520 from being undercut. The existence of the vias 540 creates a wall to prevent the dielectric layers 520 sandwiched between the metal layers 31, 32, 33 and 34 from being undercut during the etching process. This not only allows a smooth metal surface and an excellent connection with equal potential using the vias 540 and the metal layers 531, 532, 533 and 534, but also augments the sensing area or the capacitance of the gyro device, thereby enhancing the sensitivity of the gyro device.

The mechanical structure 550 of the single-chip gyro device in FIG. 6 is implemented by means of the back-end semiconductor manufacturing processes including etching, chemical vapor deposition (CVD) and planarization. The etching process is unnecessary to be implemented through ion etching. Usually, the etching process will undercut the dielectric layers 520. As the existence of the vias 540 or the metal side wall prevent the dielectric layers 520 from being undercut, the wet etching is sufficient for the manufacturing process of the present invention to generate the mechanical structure 550.

The mechanical structure 550 in FIG. 6 utilizes the metal layer 531 on the bottom to electrically connect with the circuit layer 511 on the substrate 510. In consideration of better inertial sensing and simplification of the circuit design for the layout, the mechanical structure 550 is preferred to be annular or circular.

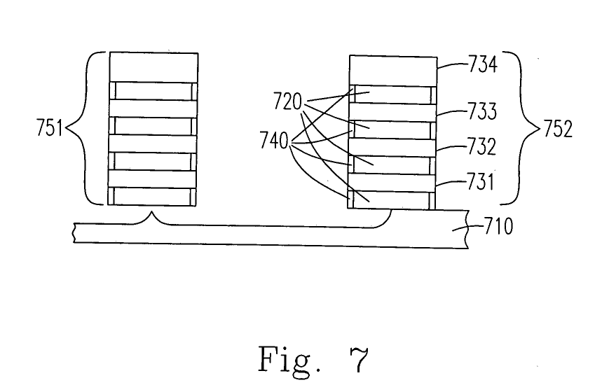

Please refer to FIG. 7, which is a schematic diagram showing the movable mechanical structure of a preferred embodiment of the present invention. The movable mechanical structure includes a substrate 710, a plurality of dielectric layers 720, a first metal layer 731, a second metal layer 732, a third metal layer 733, a fourth metal layer 734 and a plurality of vias 740. On the substrate 710 where no circuit layer is formed, the lowest one of the dielectric layers 720 is removed so as to form a movable mechanical structure 751. Contrary to the movable mechanical structure 751, the stationary mechanical structure 752 on the right is fixed on the substrate 710.

In summary, the present invention provides a design using the back-end integrated circuit manufacturing process to implement the single-chip gyro device. In contrast to the prior art designed with the rough layout and failing to fully utilize the mature standard semiconductor manufacturing process, the present invention brings up a better layout design to attain better characteristics and quality. Consequently, the simplification of the circuit configuration, the compact size fulfilled by the single-chip design, high performance and low cost make the present invention innovative, progressive and practical.

While the invention has been described in terms of what are presently considered to be the most practical and preferred embodiments, it is to be understood that the invention need not to be limited to the disclosed embodiment. On the contrary, it is intended to cover various modifications and similar arrangements included within the spirit and scope of the appended claims, which are to be accorded with the broadest interpretation so as to encompass all such modifications and similar structures.

What is claimed is:

1. A gyro device, comprising:
a substrate;
a plurality of metal layers and a plurality of dielectric layers, wherein each of said plurality of dielectric layers is located between two adjacent layers selected from a layer group consisting of said plurality of metal layers and said substrate; and
a plurality of metal side walls located on edges of said plurality of dielectric layers.

2. The gyro device of claim 1 being formed on a single chip.

3. The gyro device of claim 1, wherein said plurality of metal layers, said plurality of dielectric layers and said metal side walls form a mechanical structure.

4. The gyro device of claim 3, wherein said mechanical structure is fabricated by a back-end semiconductor manufacturing process.

5. The gyro device of claim 4, wherein said back-end semiconductor manufacturing process comprises an etching process, a chemical vapor deposition process and a planarization process.

6. The gyro device of claim 1 further comprising a circuit layer formed on said substrate.

7. The gyro device of claim 5, wherein said plurality of metal side walls and said plurality of metal layers provide an electrical connection between said circuit layer and said mechanical structure.

8. The gyro device of claim 2, wherein said mechanical structure is annular.

9. The gyro device of claim 2, wherein said mechanical structure is circular.

10. The gyro device of claim 2, wherein a lowest one of said plurality of dielectric layers is removed by an etching process based on a circuit layout design so as to make said mechanical structure movable.

11. The gyro device of claim 2, wherein said substrate is removed by an etching process based on a circuit layout design so as to make said mechanical structure movable.

12. A mechanical structure for a gyro device, comprising:
a plurality of metal layers;
a plurality of dielectric layers respectively staggered between two of said plurality of metal layers; and
a plurality of metal side walls respectively located on edges of said plurality of dielectric layers.

13. The mechanical structure of claim 12 being formed on a single-chip gyro device.

14. The mechanical structure of claim 12 is fabricated by a back-end semiconductor manufacturing process.

15. The mechanical structure of claim 14, wherein said back-end semiconductor manufacturing process comprises an etching process, a chemical vapor deposition process and a planarization process.

16. The mechanical structure of claim 13, wherein said single-chip gyro device further comprises a substrate and a circuit layer formed on said substrate.

17. The mechanical structure of claim 16, wherein said plurality of metal side walls and said plurality of metal layers provide an electrical connection between said circuit layer and said mechanical structure.

18. The mechanical structure of claim 12 being annular.

19. The mechanical structure of claim 12 being circular.

20. The mechanical structure of claim 12, wherein one of said plurality of dielectric layers is removed by an etching process based on a circuit layout design so as to make said mechanical structure movable.
